(19) United States
(12) Patent Application Publication
(10) Pub. No.: US 2026/0118997 A1
(43) Pub. Date: Apr. 30, 2026

(54) DISPLAY APPARATUS

(71) Applicant: LG Display Co., Ltd., Seoul (KR)

(72) Inventors: Youngsoo LEE, Paju-si (KR); Mirae LEE, Paju-si (KR); Youngjin CHOE, Paju-si (KR)

(73) Assignee: LG Display Co., Ltd., Seoul (KR)

(21) Appl. No.: 19/282,687

(22) Filed: Jul. 28, 2025

(30) Foreign Application Priority Data
Oct. 24, 2024 (KR) 10-2024-0146504

(51) Int. Cl. G06F 3/044; G06F 3/041

(52) U.S. Cl. CPC G06F 3/0446; G06F 3/0412; G06F 3/0448; G06F 2203/04111

(57) ABSTRACT

A display apparatus including a substrate including an active area in which a plurality of sub-pixels are disposed, a plurality of first touch electrode lines disposed on the substrate and extending in a first direction, a plurality of second touch electrode lines disposed on the substrate and extending in a second direction intersecting the first direction, and a plurality of dummy touch electrodes, each of which is disposed between the first touch electrode line and the second touch electrode line, in which the plurality of dummy touch electrodes includes a plurality of patterned dummy touch patterns, respectively.

### CROSS REFERENCE TO RELATED APPLICATION

The present application claims priority to Korean Patent Application No. 10-2024-0146504, filed Oct. 24, 2024, the entire contents of which is incorporated herein for all purposes by this reference.

### BACKGROUND OF THE INVENTION

### Technical Field

The present specification relates to a display apparatus.

### Description of the Related Art

As the information society develops, various demands for display apparatuses for displaying images are increasing, and various types of display apparatuses, such as a liquid crystal display (LCD) apparatus and an organic light-emitting diode (OLED) display apparatus, are being utilized.

Among the display apparatuses, there is an advantage in that the OLED display apparatus as the self-luminous type has a wider viewing angle and a high contrast ratio, and is lighter and thinner and has less power consumption than the LCD apparatus because it does not require a separate backlight. In addition, there is an advantage in that the OLED display apparatus can drive at a low voltage, have a fast response time, and especially have the inexpensive manufacturing cost.

To provide various functions to the user, the display apparatus provides a function of recognizing the touch by the user's finger or pen being in contact with a display panel and perform input processing based on the recognized touch.

The display apparatus may include a plurality of touch electrodes disposed on the display panel or embedded in the display panel. In addition, the display apparatus may sense the user's touch on the display panel by detecting a change in capacitance caused by the user's touch.

### BRIEF SUMMARY

The present specification is directed to providing a display apparatus in which it is possible to minimize defects of a touch panel by patterning a dummy touch electrode.

The present specification is also directed to providing a display apparatus that can be invisible externally even when a dummy touch electrode is patterned.

The present specification is also directed to providing a display apparatus in which it is possible to minimize defects of a touch panel, thereby increasing a yield of the touch panel.

Objects of the present specification are not limited to the above-described objects, and other technical objects may be inferred from the following embodiments.

According to one embodiment of the present specification, there is provided a display apparatus including a substrate including an active area in which a plurality of sub-pixels are disposed, a plurality of first touch electrode lines disposed on the substrate and extending in a first direction, a plurality of second touch electrode lines disposed on the substrate and extending in a second direction intersecting the first direction, and a plurality of dummy touch electrodes, each of which is disposed between the first touch electrode line and the second touch electrode line, in which the plurality of dummy touch electrodes includes a plurality of patterned dummy touch patterns, respectively.

According to another embodiment of the present specification, there is provided a display apparatus including a substrate, a first touch electrode disposed on the substrate and including a first main electrode extending in a first direction and a first finger electrode protruding from the first main electrode in a second direction intersecting the first direction, a second touch electrode disposed on the substrate and including a second main electrode extending in the first direction and a second finger electrode protruding from the second main electrode in the second direction, and a dummy touch electrode surrounded by the first touch electrode and the second touch electrode, in which the dummy touch electrode includes a plurality of patterned dummy touch patterns.

Detailed matters of other embodiments are included in the detailed description and accompanying drawings.

According to the embodiments of the present specification, it is possible to minimize the defects of the touch panel by patterning the dummy touch electrode.

According to the embodiments of the present specification, it is possible to provide the display apparatus that can be invisible externally even when the dummy touch electrode is patterned.

According to the embodiments of the present specification, it is possible to minimize the defects of the touch panel, thereby increasing the yield of the touch panel.

According to the embodiments of the present specification, by increasing the yield of the touch panel, it is possible to enable process optimization, thereby reducing production energy.

However, effects obtainable from the present specification are not limited to the above-described effects, and other effects that are not mentioned will be able to be clearly understood by those skilled in the art to which the present specification pertains based on the following description.

### BRIEF DESCRIPTION OF THE SEVERAL VIEWS OF THE DRAWINGS

FIG. 1 is a view illustrating a schematic configuration of a touch display apparatus according to embodiments of the present specification.

FIG. 2 is a schematic view illustrating a touch sensor structure of the touch display apparatus according to one embodiment of the present specification.

FIG. 3 is an enlarged view of the periphery of a dummy touch electrode of FIG. 2.

FIG. 4 is a schematic view illustrating a state in which a touch electrode and a dummy touch electrode are short-circuited by foreign substances disposed on a touch panel.

FIG. 5 is an enlarged view of area A of FIG. 3 and is a view specifically illustrating the touch electrode.

FIG. 6 is an enlarged view of area B in FIG. 5.

FIG. 7 is an enlarged view of area C of FIG. 5 and is a view illustrating a mesh structure of the touch electrode.

FIG. 8 is a view illustrating a bridge electrode and a dummy bridge electrode according to one embodiment of the present specification.

FIG. 9 is a cross-sectional view illustrating a sub-pixel of the touch display apparatus according to one embodiment of the present specification.

FIG. 10 is a view illustrating the arrangement of the dummy bridge electrode according to one embodiment of the present specification.

FIG. 11 is a cross-sectional view along line M-M′ in FIG. 10.

FIG. 12 is a view illustrating the arrangement of the bridge electrode according to one embodiment of the present specification.

FIG. 13 is a cross-sectional view along line N-N′ in FIG. 12.

### DETAILED DESCRIPTION

Hereinafter, embodiments will be described with reference to the accompanying drawings. In the specification, when a first component (or an area, a layer, a portion, etc.) is described as “on,” “connected,” or “coupled to” a second component, it means that the first component may be directly connected/coupled to the second component or a third component may be disposed therebetween.

The same reference numerals indicate the same components. In addition, in the drawings, thicknesses, proportions, and dimensions of components are exaggerated for effective description of technical contents. The term “and/or” includes all one or more combinations that may be defined by the associated configurations.

Terms such as first and second may be used to describe various components, but the components are not limited by the terms. The terms are used only for the purpose of distinguishing one component from another. For example, a first component may be referred to as a second component, and similarly, the second component may also be referred to as the first component without departing from the scopes of the embodiments. The singular includes the plural unless the context clearly dictates otherwise.

Terms such as “under,” “at a lower side,” “above,” and “at an upper side” are used to describe the relationship between the components illustrated in the drawings. The terms are relative concepts and are described with respect to directions marked in the drawings.

It should be understood that term such as “includes” or “has” is intended to specify the presence of features, numbers, steps, operations, components, parts, or a combination thereof described in the specification and does not preclude the presence or addition possibility of one or more other features, numbers, steps, operations, components, parts, or combinations thereof in advance.

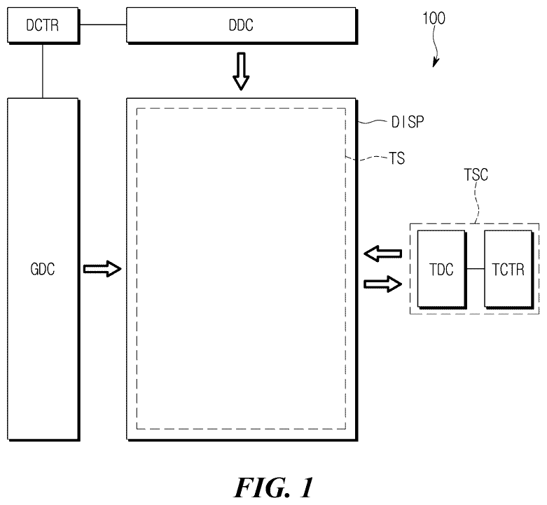

FIG. 1 is a view illustrating a schematic configuration of a touch display apparatus according to embodiments of the present specification.

Referring to FIG. 1, a touch display apparatus 100 may be an apparatus including both a display function of displaying an image and a touch sensing function of sensing a user's touch, but is not limited thereto.

The touch display apparatus 100 may be an electroluminescent display apparatus or a micro light-emitting diode display apparatus that includes a touch sensor. The electroluminescent display apparatus including the touch sensor may be an organic light-emitting diode (OLED) display apparatus, a quantum-dot light-emitting diode display apparatus, or an inorganic light-emitting diode display apparatus.

Hereinafter, the touch display apparatus 100 of the present specification is described as being an OLED display apparatus, but is not limited thereto.

The touch display apparatus 100 according to the present embodiment may be a vehicle display apparatus, but is not limited thereto. The description of the touch display apparatus 100 of the present specification may be applied without limitation to the type of the apparatus as long as a display apparatus is an apparatus including a display function. For example, the display apparatus 100 may be applied to a mobile device, a video phone, a smart watch, a watch phone, a wearable apparatus, a foldable apparatus, a rollable apparatus, a bendable apparatus, a flexible apparatus, a curved apparatus, a sliding apparatus, a variable apparatus, an electronic notebook, an e-book, a portable multimedia player (PMP), a personal digital assistant (PDA), an MP3 player, a mobile medical device, a desktop PC, a laptop PC, a netbook computer, a workstation, a navigation system, a vehicle display apparatus, a theater display apparatus, a television, a wallpaper device, a signage device, a game device, a laptop computer, a monitor, a camera, a camcorder, a home appliances, etc.

To provide an image display function, the touch display apparatus 100 according to embodiments of the present specification may include a display panel DISP in which a plurality of data lines and a plurality of gate lines are disposed and a plurality of sub-pixels defined by the plurality of data lines and the plurality of gate lines are arranged, a data driving circuit DDC for driving the plurality of data lines, a gate driving circuit GDC for driving the plurality of gate lines, and a display controller DCTR for controlling the operation of the data driving circuit DDC and the gate driving circuit GDC.

Each of the data driving circuit DDC, the gate driving circuit GDC, and the display controller DCTR may be implemented as one or more individual components. In some cases, two or more of the data driving circuit DDC, the gate driving circuit GDC, and the display controller DCTR may be implemented as one integrated component. For example, the data driving circuit DDC and the display controller DCTR may be implemented as a single integrated circuit (IC) chip.

To provide a touch sensing function, the touch display apparatus 100 according to the embodiments of the present specification may include a touch panel TS including a plurality of touch electrode lines, and a touch sensing circuit TSC for supplying a touch driving signal to the touch panel TS, detecting a touch sensing signal from the touch panel TS, and sensing whether a user touches the touch panel TS or a touch location (touch coordinates) based on the detected touch sensing signal.

The touch sensing circuit TSC may include, for example, the touch driving circuit TDC for supplying the touch driving signal to the touch panel TS and detecting the touch sensing signal from the touch panel TS, a touch controller TCTR for sensing whether the user touches the touch panel TS and/or the touch location based on the touch sensing signal detected by the touch driving circuit TDC, etc.

The touch driving circuit TDC and the touch controller TCTR may be implemented as separate components, or, in some cases, may be implemented as a single integrated component.

Meanwhile, each of the data driving circuit DDC, the gate driving circuit GDC, and the touch driving circuit TDC may be implemented as one or more integrated circuits and implemented as a chip on glass (COG) type, a chip on film (COF) type, a tape carrier package (TCP) type, etc., in terms of electrical connection with the display panel DISP, and the gate driving circuit GDC may also be implemented as a gate in panel (GIP) type.

As will be described below, the touch panel TS may include a plurality of touch electrode lines to which the touch driving signal may be applied or the touch sensing signal may be detected, and a plurality of touch routing lines for connecting the plurality of touch electrode lines to the touch driving circuit TDC.

The touch panel TS may exist outside the display panel DISP. That is, the touch panel TS and the display panel DISP may be manufactured separately and coupled. The touch panel TS is called an external type.

Alternatively, the touch panel TS may be embedded in the display panel DISP. The touch panel TS is called an embedded type. Hereinafter, for convenience of description, an example in which the touch panel TS is an embedded type will be described.

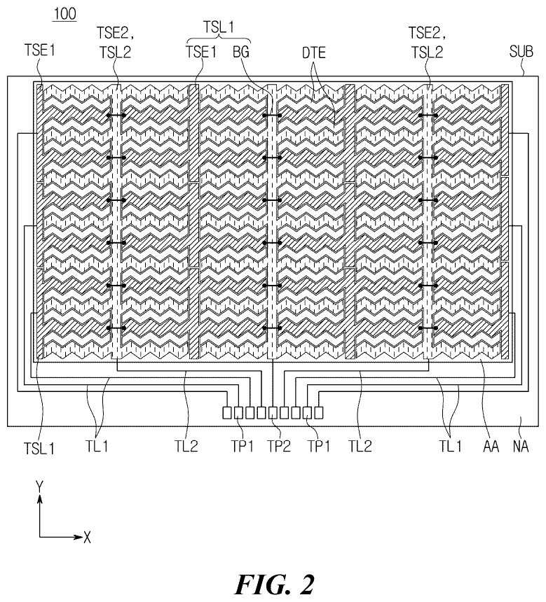

FIG. 2 is a schematic view illustrating a touch sensor structure of the touch display apparatus according to one embodiment of the present specification.

Referring to FIG. 2, in the present specification, a first direction and a second direction may be relatively different directions, and as an example, the first direction may be an x-axis direction and the second direction may be a y-axis direction. Conversely, the first direction may be the y-axis direction and the second direction may be the x-axis direction.

In addition, the first direction (the X-direction) and the second direction (the Y-direction) may intersect each other. The first direction (the X-direction) and the second direction (the Y-direction) may be orthogonal, but are not limited thereto.

A mutual-capacitive touch sensor structure of the touch display apparatus 100 may include a plurality of first touch electrode lines TSL1, a plurality of second touch electrode lines TSL2, and a plurality of dummy touch electrodes DTE.

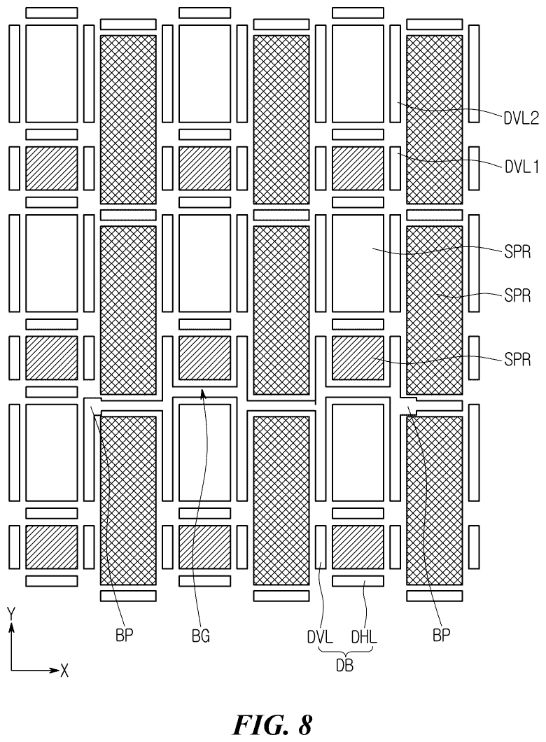

The plurality of first touch electrode lines TSL1, the plurality of second touch electrode lines TSL2, and the plurality of dummy touch electrodes DTE are located on an active area AA of a substrate SUB. Specifically, the plurality of first touch electrode lines TSL1, the plurality of second touch electrode lines TSL2, and the plurality of dummy touch electrodes DTE may be located on an encapsulation layer ENCAP (see FIG. 8) disposed on the active area AA of the substrate SUB.

Each of the plurality of first touch electrode lines TSL1 may extend in the first direction (the X direction) and may be disposed repeatedly in the second direction (the Y direction). Each of the plurality of second touch electrode lines TSL2 may extend in the second direction (the Y direction) and may be disposed repeatedly in the first direction (the X direction).

The second touch electrode line TSL2 may be disposed between the adjacent first touch electrode lines TSL1, and the first touch electrode line TSL1 may be disposed between the adjacent second touch electrode lines TSL2.

The plurality of dummy touch electrodes DTE may be disposed between the first touch electrode lines TSL1 and the second touch electrode lines TSL2. The dummy touch electrodes DTE may be disposed repeatedly in the first direction (the X direction) and the second direction (the Y direction).

The first touch electrode lines TSL1, the second touch electrode lines TSL2, and the dummy touch electrodes DTE may be separated and spaced apart from each other.

The touch sensor structure may include a plurality of first touch routing lines TL1 connected to the plurality of first touch electrode lines TSL1, respectively, and a plurality of second touch routing lines TL2 connected to the plurality of second touch electrode lines TSL2, respectively.

Each of the plurality of first touch electrode lines TSL1 is electrically connected to a first touch pad TP1 through one or more first touch routing lines TL1. That is, a first touch electrode TSE1 disposed at an outermost edge of the active area AA among a plurality of first touch electrodes TSE1 included in one first touch electrode line TSL1 is electrically connected to the first touch pad TP1 through the first touch routing line TL1.

Each of the plurality of second touch electrode lines TSL2 is electrically connected to a second touch pad TP2 through one or more second touch routing lines TL2.

The plurality of first touch routing lines TL1, the plurality of second touch routing lines TL2, the first touch pads TP1, and the second touch pads TP2 may be disposed in a non-active area NA of the substrate SUB.

The first touch electrode line TSL1 may be electrically connected to the touch driving circuit TDC through the first touch routing line TL1 and the first touch pad TP1. Likewise, the second touch electrode line TSL2 may be electrically connected to the touch driving circuit TDC through the second touch routing line TL2 and the second touch pad TP2.

FIG. 2 exemplarily illustrates three first touch electrode lines TSL1 and three second touch electrode lines TSL2, but the number of first touch electrode lines TSL1 and the number of second touch electrode lines TSL2 are not limited thereto.

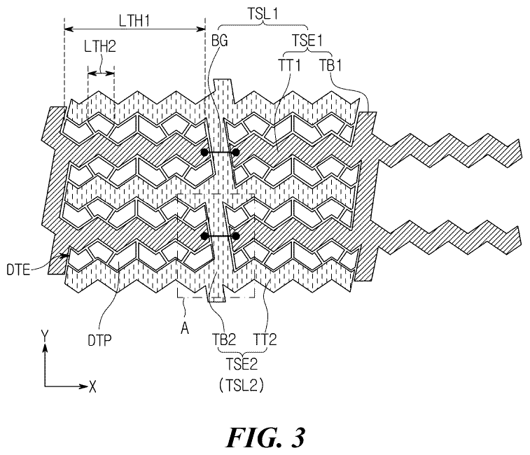

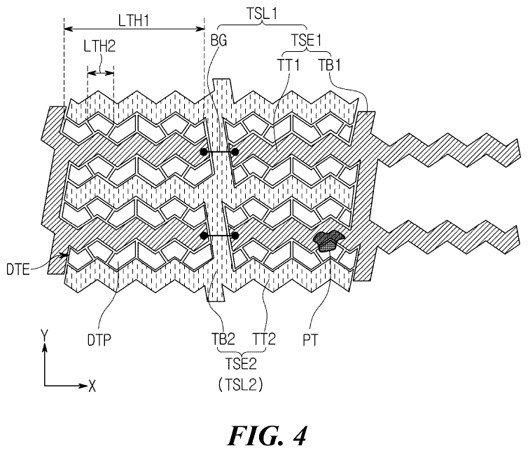

FIG. 3 is an enlarged view of the periphery of a dummy touch electrode of FIG. 2. FIG. 4 is a schematic view illustrating a state in which a touch electrode and a dummy touch electrode are short-circuited by foreign substances disposed on a touch panel.

FIG. 3 illustrates a specific configuration of the touch electrodes illustrated in FIG. 2.

Referring to FIGS. 2 to 4, each first touch electrode line TSL1 may be composed of the plurality of first touch electrodes TSE1 and a plurality of bridge electrodes BG connecting the plurality of first touch electrodes TSE1. Two adjacent first touch electrodes TSE1 in the first direction (the X direction) may be connected by at least one bridge electrode BG.

The first touch electrode TSE1 may include a first main electrode TB1 extending in the second direction (the Y direction) and a plurality of first finger electrodes TT1 protruding in the first direction (the X direction) from the first main electrode TB1.

The plurality of first finger electrodes TT1 may protrude toward at least one of one side and/or the other side from the first main electrode TB1. The plurality of first finger electrodes TT1 may be connected to the first main electrode TB1, and the plurality of first finger electrodes TT1 may be separated and spaced apart from each other in the second direction (the Y direction).

Each of the first main electrode TB1 and the first finger electrode TT1 may have a zigzag-shaped exterior.

The first touch electrode TSE1 disposed at the outermost edge of the active area AA among the plurality of first touch electrodes TSE1 may include the main electrode TB1 and the plurality of first finger electrodes TT1 disposed on one side of the first main electrode TB1. The first touch electrode TSE1 disposed inside the active area AA among the plurality of first touch electrodes TSE1 may include the first main electrode TB1 and a plurality of first finger electrodes TT1 disposed on both sides of the first main electrode TB1.

FIGS. 2 and 3 exemplarily illustrate each first touch electrode TSE1 including two first finger electrodes TT1 spaced apart from each other in the second direction (the Y direction), but the number of first finger electrodes TT1 is not limited thereto.

The number of bridge electrodes BG electrically connecting two adjacent first touch electrodes TSE1 in the first direction (the X direction) may be less than or equal to the number of first finger electrodes TT1 of the first touch electrode TSE1.

The bridge electrode BG may electrically connect two adjacent first finger electrodes TT1 in the first direction (the X direction). The bridge electrode BG may be disposed on a different layer from the first touch electrodes TSE1. For example, the bridge electrode BG may be disposed on a lower layer than the first touch electrodes TSE1.

Each second touch electrode line TSL2 may be formed as one second touch electrode TSE2.

The second touch electrode TSE2 may include a second main electrode TB2 extending in the second direction (the Y direction) and a plurality of second finger electrodes TT2 protruding in the first direction (the X direction) from the second main electrode TB2.

The plurality of second finger electrodes TT2 may protrude toward at least one of one side and/or the other side from the second main electrode TB2. The plurality of second finger electrodes TT1 may be connected to the second main electrode TB2, and the plurality of second finger electrodes TT1 may be separated and spaced apart from each other in the second direction (the Y direction).

Each of the second main electrode TB2 and the second finger electrode TT2 may have a zigzag-shaped exterior.

The second main electrode TB2 may extend in the second direction (the Y direction) across the entire active area AA. The second touch electrode TSE2 may include the plurality of second finger electrodes TT2 disposed on both sides of the second main electrode TB2.

The first main electrode TB1 and the second main electrode TB2 may extend in the second direction (the Y direction) and may be disposed alternately in the first direction (the X direction).

The plurality of first finger electrodes TT1 and the plurality of second finger electrodes TT2 may be disposed between the first main electrode TB1 and the second main electrode TB2. The first finger electrodes TT1 and the second finger electrodes TT2 disposed between the first main electrode TB1 and the second main electrode TB2 may be disposed alternately in the second direction (the Y direction).

The dummy touch electrode DTE may be disposed between the first touch electrode line TSL1 and the second touch electrode line TSL2 that are adjacent to each other. The dummy touch electrode DTE may be surrounded by the first touch electrode line TSL1 and the second touch electrode line TSL2 that are adjacent to each other. The dummy touch electrode DTE may be surrounded by the first main electrode TB1, the first finger electrode TT1, the second main electrode TB2, and the second finger electrode TT2.

Specifically, the dummy touch electrode DTE may be disposed between the first main electrode TB1 and the second main electrode TB2 in the first direction (the X direction). One of the first main electrode TB1 and the second main electrode TB2 may be disposed on one side of the dummy touch electrode DTE in the first direction (the X direction), and the other of the first main electrode TB1 and the second main electrode TB2 may be disposed on the other side of the dummy touch electrode DTE in the first direction (the X direction).

The first main electrode TB1, the second main electrode TB2, and the dummy touch electrode DTE may be separated and disposed to be spaced apart from each other. That is, a predetermined distance exists between the first main electrode TB1 and the dummy touch electrode DTE. The predetermined distance exists between the second main electrode TB2 and the dummy touch electrode DTE.

The dummy touch electrode DTE may be disposed between the first finger electrode TT1 and the second finger electrode TT2 in the second direction (the Y direction). One of the first finger electrode TT1 and the second finger electrode TT2 may be disposed on one side of the dummy touch electrode DTE in the second direction (the Y direction), and the other of the first finger electrode TT1 and the second finger electrode TT2 may be disposed on the other side of the dummy touch electrode DTE in the second direction (the Y direction).

The first finger electrode TT1, the second finger electrode TT2, and the dummy touch electrode DTE may be separated and disposed to be spaced apart from each other. That is, a predetermined distance exists between the first finger electrode TT1 and the dummy touch electrode DTE. A predetermined distance exists between the second finger electrode TT2 and the dummy touch electrode DTE.

The dummy touch electrode DTE is an electrically floating electrode. The dummy touch electrode DTE is not electrically connected to the touch driving circuit TDC.

The dummy touch electrode DTE may have a zigzag-shaped exterior.

Each of the plurality of dummy touch electrodes DTE may include a plurality of dummy touch patterns DTP.

Each of the plurality of dummy touch electrodes DTE extending in the first direction (the X direction) may include the plurality of dummy touch patterns DTP arranged in the first direction (the X direction). The plurality of dummy touch patterns DTP may be patterned, separated, and disposed to be spaced apart from each other.

Since the dummy touch electrode DTE includes the plurality of patterned dummy touch patterns DTP, it is possible to minimize defects of the touch panel TS and increase the yield of the touch panel TS. Furthermore, by increasing the yield of the touch panel TS, it is possible to enable process optimization, thereby reducing production energy.

Specifically, a foreign substance PT may penetrate onto the touch panel TS. The foreign substance PT may cause a short circuit between adjacent electrodes, which may be determined to be a defect. For example, since the foreign substance PT may be disposed between the first touch electrode TSE1 and the dummy touch electrode DTE that are adjacent to each other, the first touch electrode TSE1 may be short-circuited to the entire area of the dummy touch electrode DTE.

In this case, even though there is no short between the first touch electrode TSE1 and the second touch electrode TSE2, the capacitance of the first touch electrode TSE1 may fluctuate significantly due to the short between the first touch electrode TSE1 and the dummy touch electrode DTE, and thus it is determined that the touch panel TS is defective during the inspection of the touch panel TS, thereby decreasing the yield of the touch panel TS.

However, since the dummy touch electrode DTE includes the plurality of patterned dummy touch patterns DTP, even when the foreign substance PT causes a short circuit between the first touch electrode TSE1 and the dummy touch electrode DTE that are adjacent to each other, the first touch electrode TSE1 may be short-circuited with some of the dummy touch patterns DTP. Accordingly, even when the foreign substance PT is disposed on the touch panel TS, it is possible to minimize a change in capacitance of the first touch electrode TSE1 due to the short. Furthermore, it is possible to minimize the determination of the first touch electrode TSE1 being defective during the inspection of the touch panel TS, thereby increasing the yield of the touch panel TS.

Each of the plurality of dummy touch electrodes DTE may extend in the first direction (the X direction). Each of the plurality of dummy touch electrodes DTE may include a first length LTH1 extending in the first direction (the X direction). The plurality of dummy touch patterns DTP may include a second length LTH2 extending in the first direction (the X direction).

The lengths of the plurality of dummy touch patterns DTP in the first direction (the X direction) may range from 15% to 20% or range from 13% to 25% of the length of the dummy touch electrode DTE in the first direction (the X direction).

That is, the second length LTH2 may range from 15% to 20% or from 13% to 25% of the first length LTH1.

The first finger electrode TT1 and the second finger electrode TT2 may have lengths extending in the first direction (the X direction) that is substantially the same as that of the dummy touch electrode DTE. Each of the first finger electrode TT1 and the second finger electrode TT2 may include the first length LTH1 extending in the first direction (the X direction).

In this case, the length of the dummy touch pattern DTP in the first direction (the X direction) may range from 15% to 20% or from 13% to 25% of the length of the first finger electrode TT1 or the second finger electrode TT2.

When the second length LTH2 is within the above range, the dummy touch electrode DTE may be patterned to minimize defects of the touch panel TS. In addition, even when the dummy touch electrode DTE is patterned, the dummy touch electrode DTE and the dummy touch pattern DTP may be invisible externally.

For example, when the second length LTH2 is less than 13% of the first length LTH1, the dummy touch electrode DTE and the dummy touch pattern DTP may form a heterogeneous feeling and thus may be visible externally.

In addition, when the second length LTH2 is greater than 25% of the first length LTH1, a change in capacitance may increase when a short circuit occurs, and thus it may be determined that the touch panel TS is defective during defect detection of the touch panel TS, thereby decreasing the yield of the touch panel TS.

FIG. 3 illustrates the dummy touch electrode DTE including six dummy touch patterns DTP, but the number of dummy touch patterns DTP included in one dummy touch electrode DTE is not limited thereto. For example, the number of dummy touch patterns DTP included in one dummy touch electrode DTE may range from 5 to 8.

The first touch electrode TSE1, the second touch electrode TSE2, and the dummy touch electrode DTE may be disposed on the same layer. A predetermined distance exists between the first touch electrode TSE1 and the dummy touch electrode DTE. A predetermined distance exists between the second touch electrode TSE2 and the dummy touch electrode DTE. The first touch electrode TSE1, the second touch electrode TSE2, and the dummy touch electrode DTE are not connected.

The bridge electrode BG may be disposed on a different layer from the second main electrodes TB2. For example, the bridge electrode BG may be disposed on a lower layer than the second main electrodes TB2.

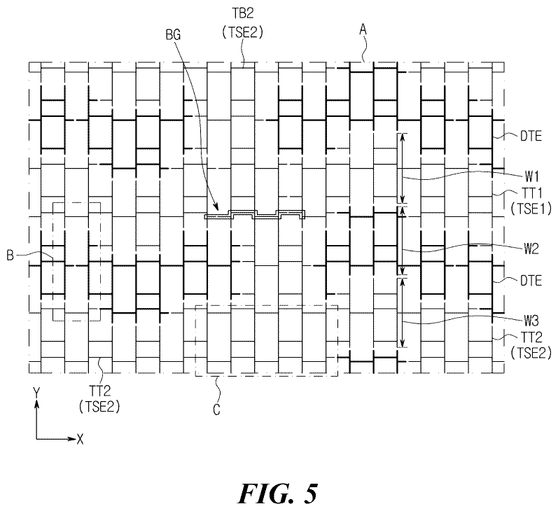

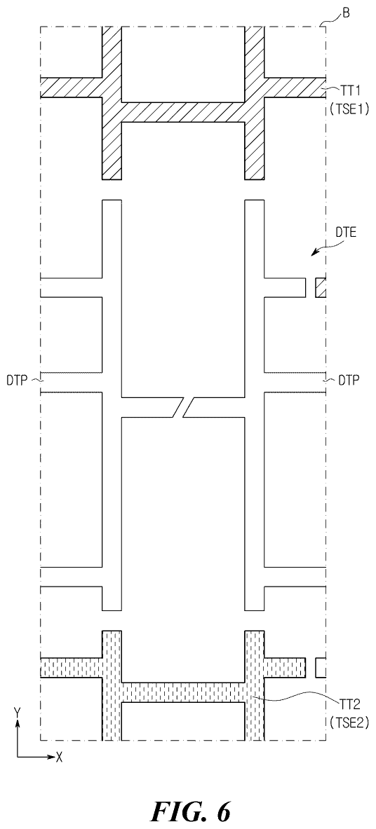

FIG. 5 is an enlarged view of area A of FIG. 3 and is a view specifically illustrating the touch electrode. FIG. 6 is an enlarged view of area B in FIG. 5.

Referring to FIGS. 3 to 6, the first main electrode TB1 and the first finger electrode TT1 of the first touch electrode TSE1, the dummy touch electrode DTE, and the second main electrode TB2 and the second finger electrode TT2 of the second touch electrode TSE2 may all have a mesh structure.

The first touch electrode TSE1 with the mesh structure and the dummy touch electrode DTE with the mesh structure are spaced a predetermined distance from each other. The second touch electrode TSE2 with the mesh structure and the dummy touch electrode DTE with the mesh structure are spaced a predetermined distance from each other. The first touch electrode TSE1 with the mesh structure and the second touch electrode TSE2 with the mesh structure are spaced a predetermined distance from each other.

The mesh structure of the first touch electrode TSE1 and the mesh structure of the dummy touch electrode DTE are disconnected. The mesh structure of the second touch electrode TSE2 and the mesh structure of the dummy touch electrode DTE are disconnected. The mesh structure of the first touch electrode TSE1 and the mesh structure of the second touch electrode TSE2 are disconnected.

The first touch electrode TSE1, the dummy touch electrode DTE, and the second touch electrode TSE2 may be formed by cutting the touch electrode with the mesh structure formed in the active area AA of the substrate SUB into a predetermined shape.

A direction of cross sections between the adjacent dummy touch patterns DTP may differ from a direction of cross sections between the dummy touch electrode DTE and the first touch electrode TSE1 and a direction of cross sections between the dummy touch electrode DTE and the second touch electrode TSE2.

For example, the cross sections between the adjacent dummy touch patterns DTP may be formed in a direction between the first direction (the X direction) and the second direction (the Y direction). The cross sections between the adjacent dummy touch patterns DTP may be formed in a direction that is tilted to the first direction (the X direction) and the second direction (the Y direction). The cross sections of the adjacent dummy touch patterns DTP may be formed to face each other and in substantially the same direction.

The cross sections between the dummy touch electrode DTE and the first touch electrode TSE1, and the cross sections between the dummy touch electrode DTE and the second touch electrode TSE2 may be formed in one of the first direction (the X direction) and the second direction (the Y direction). The cross sections between the dummy touch electrode DTE and the first touch electrode TSE1 that are adjacent to each other may be formed to face each other and in substantially the same direction. The cross sections between the dummy touch electrode DTE and the second touch electrodes TSE2 that are adjacent to each other may be formed to face each other and in substantially the same direction.

In addition, the cross sections between the first touch electrode TSE1 and the second touch electrode TSE2 that are adjacent to each other may be formed in one of the first direction (the X direction) or the second direction (the Y direction). The cross sections between the first touch electrode TSE1 and the second touch electrodes TSE2 that are adjacent to each other may be formed to face each other and in substantially the same direction. The cross sections between the first touch electrode TSE1 and the second touch electrodes TSE2 that are adjacent to each other may be formed to face each other and in substantially the same direction.

Through the direction of the cross sections, it is possible to more easily distinguish whether the cross sections are formed between the first touch electrode TSE1, the dummy touch electrode DTE, and the second touch electrode TSE2 or formed between the adjacent dummy touch patterns DTP. For example, when the cross sections are formed in a direction between the first direction (the X direction) and the second direction (the Y direction) between the adjacent dummy touch patterns DTP, when the cross-sections formed in the direction between the first direction (the X direction) and the second direction (the Y direction) are confirmed, it can be seen that the corresponding cross sections are the cross sections between the adjacent dummy touch patterns DTP.

A width W1 of the first finger electrode TT1, a width W2 of the dummy touch electrode DTE, and a width W3 of the second finger electrode TT2 may be the same. Here, the width refers to dimensions of the first finger electrode TT1, the dummy touch electrode DTE, and the second finger electrode TT2 in the second direction (the Y direction).

As in the present embodiment, the first main electrode TB1 and the first finger electrode TT1 of the first touch electrode TSE1, the second main electrode TB2 and the second finger electrode TT2 of the second touch electrode TSE2, and the outer shape of the dummy touch electrode DTE may be designed to have a zigzag-shaped exterior, the width W1 of the first finger electrode TT1, the width W2 of the dummy touch electrode DTE, and the width W3 of the second finger electrode TT2 may be designed to be the same, and the bridge electrode BG and a bridge pad BP may be disposed in a distributed manner, thereby preventing the pattern of the touch electrode from being visible by the user.

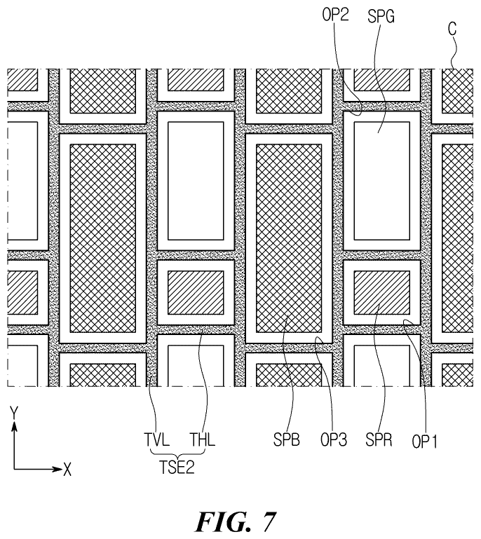

FIG. 7 is an enlarged view of area C of FIG. 5 and is a view illustrating a mesh structure of the touch electrode.

Referring to FIGS. 5 and 7, the second touch electrode TSE2 has a mesh structure that does not overlap light-emitting areas of first to third sub-pixels SPR, SPG, and SPB. That is, each of the first to third sub-pixels SPR, SPG, and SPB may include a light-emitting area and a non-light-emitting area around the light-emitting area, and the second touch electrode TSE2 may be disposed in the non-light-emitting area.

For example, the second touch electrode TSE2 with the mesh structure is formed of a plurality of horizontal sensor lines THL and a plurality of vertical sensor lines TVL.

The plurality of horizontal sensor lines THL may extend in the first direction (the X direction) (e.g., the x-axis direction) and may be arranged in parallel. The plurality of vertical sensor lines TVL may extend in the second direction (the Y direction) (e.g., the y-axis direction) intersecting the first direction (the X direction) and may be arranged in parallel. The plurality of horizontal sensor lines THL and the plurality of vertical sensor lines TVL may be connected.

The second touch electrode TSE2 with the mesh structure formed of the horizontal and vertical sensor lines THL and TVL may have a first opening OP1 corresponding to the light-emitting area of the first sub-pixel SPR, a second opening OP2 corresponding to the light-emitting area of the second sub-pixel SPG, and a third opening OP3 corresponding to the light-emitting area of the third sub-pixel SPB. The first opening OP1 of the second touch electrode TSE2 may have a greater area than the light-emitting area of the first sub-pixel SPR. The second opening OP2 of the second touch electrode TSE2 may have a greater area than the light-emitting area of the second sub-pixel SPG. The third opening OP3 of the second touch electrode TSE2 may have a greater area than the light-emitting area of the third sub-pixel SPB.

The first to third openings OP1, OP2, and OP3 may have the same area, or at least one thereof may have a different area. For example, when the first sub-pixel SPR is a red sub-pixel, the second sub-pixel SPG is a green sub-pixel, and the third sub-pixel SPB is a blue sub-pixel, the third opening OP3 may have a greater area than the second opening OP2, and the second opening OP2 may have a greater area than the first opening OP1. The first opening OP1 and the second opening OP2 may be disposed at one side of the third opening OP3.

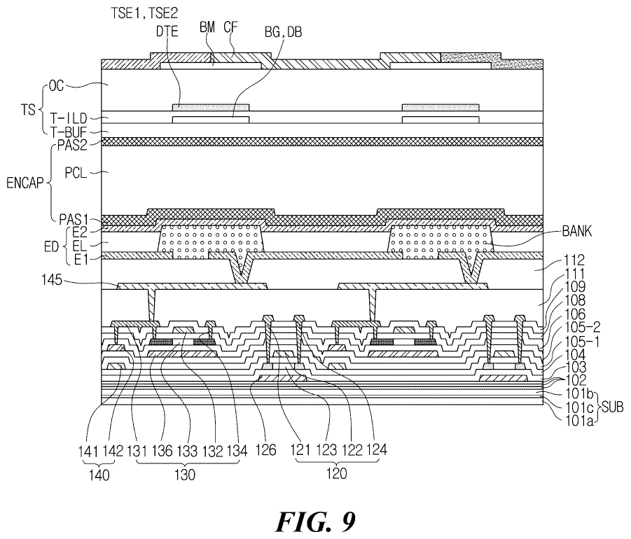

The horizontal and vertical sensor lines THL and TVL forming the second touch electrode TSE2 with the mesh structure may have smaller line widths and overlap a bank BANK (see FIG. 9) disposed in the active area AA of the substrate SUB, thereby preventing an aperture ratio of the sub-pixel from being reduced by the second touch electrode TSE2.

FIG. 7 exemplarily illustrates a part of the second touch electrode TSE2, but the first touch electrode TSE1 and the dummy touch electrode DTE also have the same mesh structure as the second touch electrode TSE2.

That is, each of the first to third sub-pixels SPR, SPG, and SPB may include a light-emitting area and a non-light-emitting area around the light-emitting area, and the first touch electrode TSE1 and the dummy touch electrode DTE may be disposed in the non-light-emitting area.

The horizontal and vertical sensor lines THL and TVL forming the first touch electrode TSE1 and the dummy touch electrode DTE that have the mesh structure have smaller lines widths and overlap the bank (see FIG. 9) disposed in the active area AA of the substrate SUB, thereby preventing the aperture ratio of the sub-pixel from being reduced by the first touch electrode TSE1 and the dummy touch electrode DTE.

FIG. 8 is a view illustrating a bridge electrode and a dummy bridge electrode according to one embodiment of the present specification.

Referring to FIG. 8, the bridge electrode BG and the dummy bridge electrode DB may be disposed on a lower layer than the first touch electrode TSE1, the dummy touch electrode DTE, and the second touch electrode TSE2. The dummy bridge electrode DB may overlap the first touch electrode TSE1, the dummy touch electrode DTE, and the second touch electrode TSE2. The bridge electrode BG may overlap a part of the second touch electrode TSE2.

The dummy bridge electrode DB includes a plurality of horizontal dummy lines DHL and a plurality of vertical dummy lines DVL. The plurality of horizontal dummy lines DHL may extend in the first direction (the X direction) and may be arranged in parallel, and the plurality of vertical dummy lines DVL may extend in the second direction (the Y direction) intersecting the first direction (the X direction) and may be arranged in parallel. The plurality of horizontal dummy lines DHL and the plurality of vertical dummy lines DVL are not connected.

The horizontal and vertical dummy lines DHL and DVL constituting the dummy bridge electrode DB may overlap the horizontal and vertical sensor lines THL and TVL constituting the first touch electrode TSE1, the dummy touch electrode DTE, and the second touch electrode TSE2.

The plurality of horizontal dummy lines DHL may overlap the plurality of horizontal sensor lines THL, and the plurality of vertical dummy lines DVL may overlap the plurality of vertical sensor lines TVL.

The plurality of horizontal dummy lines DHL and the plurality of vertical dummy lines DVL may be spaced apart from each other at locations corresponding to areas in which the plurality of horizontal sensor lines THL and the plurality of vertical sensor lines TVL are connected.

The plurality of vertical dummy lines DVL include a plurality of first vertical dummy lines DVL1 and a plurality of second vertical dummy lines DVL2 that are alternately disposed in the second direction (the Y direction). The plurality of second vertical sensor lines DVL2 may be longer than the plurality of first vertical sensor lines DVL1.

The plurality of first vertical dummy lines DVL1 and the plurality of second vertical dummy lines DVL2 may be spaced apart from each other at the locations corresponding to the areas in which the plurality of horizontal sensor lines THL and the plurality of vertical sensor lines TVL are connected.

The bridge electrode BG may be disposed on the same layer as the dummy bridge electrode DB and connected to the plurality of vertical dummy lines DVL.

One bridge pad BP to which the first touch electrode TSE1 is connected may be disposed at each of both ends of the bridge electrode BG. A width of the bridge pad BP may be greater than the line width of the horizontal dummy line DHL and the line width of the vertical dummy line DVL.

The horizontal and vertical dummy lines DHL and DVL of the bridge electrode BG and the dummy bridge electrode DB may have smaller line width and overlap the bank BANK (see FIG. 9) disposed in the active area AA of the substrate SUB, thereby preventing the aperture ratio of the sub-pixel from being reduced by the bridge electrode BG and the dummy bridge electrode DB.

FIG. 9 is a cross-sectional view illustrating a sub-pixel of the touch display apparatus according to one embodiment of the present specification.

Referring to FIG. 9, the touch display apparatus 100 may include the substrate SUB, a first thin film transistor 120, a second thin film transistor 130, a light-emitting element ED, the encapsulation layer ENCAP, the touch panel TS, and a color filter CF. At least one insulating layer may be disposed between the light-emitting element ED and the substrate SUB.

The substrate SUB may provide a space in which various components may be disposed thereon.

The substrate SUB may include one or more plastic materials. For example, the substrate SUB may be a multi-substrate including a plurality of plastic materials, such as polyimide, etc. For example, the substrate SUB may include a first substrate portion 101a and a second substrate portion 101b each including a plastic material, and a third substrate portion 101c including an inorganic insulation material between the first substrate portion 101a and the second substrate portion 101b, but the embodiments of the present specification are not limited thereto.

The substrate SUB may include a rigid substrate. However, the embodiments of the present specification are not limited thereto, and the substrate SUB may include a flexible substrate.

A buffer layer 102 may be disposed on the substrate SUB. The buffer layer 102 can minimize or delay the diffusion of moisture or oxygen penetrating the substrate SUB. The buffer layer 102 may be formed by alternately stacking silicon nitride (SiNx) and silicon oxide (SiOx) at least once, but the embodiments of the present specification are not limited thereto.

A first light-blocking layer 126 may be disposed on the buffer layer 102. The first light-blocking layer 126 can prevent light from transmitting a first semiconductor layer 123 of the first thin film transistor 120. For example, the first semiconductor layer 123 may be disposed to overlap the first light-blocking layer 126. The first light-blocking layer 126 may be formed of a single layer or multiple layers formed of one of molybdenum (Mo), aluminum (Al), chromium (Cr), nickel (Ni), neodymium (Nd), and copper (Cu) or an alloy thereof, but the embodiments of the present specification are not limited thereto.

A first insulating layer 103 may be disposed on the buffer layer 102 and the first light-blocking layer 126. The first insulating layer 103 can prevent a short circuit between a component of the first thin film transistor 120 and the first light-blocking layer 126. The first insulating layer 103 may be formed of the same material as the buffer layer 102, but the embodiments of the present specification are not limited thereto. For example, the first insulating layer 103 may be formed of an inorganic insulation material, such as silicon nitride (SiNx) or silicon oxide (SiOx), but the embodiments of the present specification are not limited thereto.

The first thin film transistor 120 may be disposed on the first insulating layer 103. The first thin film transistor 120 may include a first source electrode 121, a first gate electrode 122, the first semiconductor layer 123, and a first drain electrode 124.

The first semiconductor layer 123 may be disposed on the first insulating layer 103. The first semiconductor layer 123 may include a metal oxide semiconductor, such as indium-gallium-zinc oxide (IGZO), and a silicon-based semiconductor material, such as amorphous silicon, polycrystalline silicon, etc., but the embodiments of the present specification are not limited thereto. The first semiconductor layer 123 may include a channel area, a source area, and a drain area.

Since the polycrystalline semiconductor layer has higher mobility than the amorphous semiconductor layer and the oxide semiconductor layer, power consumption can be less, and reliability can be excellent. Accordingly, a driving transistor may be formed of the polycrystalline semiconductor layer.

A second insulating layer 104 may be disposed on the first semiconductor layer 123. The second insulating layer 104 may be formed of the same material as the first insulating layer 103 and can prevent a short circuit between the first semiconductor layer 123 and another component of the first thin film transistor 120.

The first gate electrode 122 may be disposed on the second insulating layer 104. The first gate electrode 122 may be disposed on the second insulating layer 104 to overlap the channel area of the first semiconductor layer 123. The first gate electrode 122 may be formed of a single layer or multiple layers formed of molybdenum (Mo), copper (Cu), titanium (Ti), aluminum (Al), chromium (Cr), gold (Au), nickel (Ni), neodymium (Nd), or a compound thereof, but the embodiments of the present specification are not limited thereto. The first gate electrode 122 may be disposed along with a gate line.

Third insulating layers 105-1 and 105-2 may be disposed on the first gate electrode 122. The third insulating layers 105-1 and 105-2 may be formed by alternately stacking silicon nitride (SiNx) and silicon oxide (SiOx) at least once, but the embodiments of the present specification are not limited thereto. For example, a 3-1 insulating layer 105-1 may include silicon oxide (SiOx), and a 3-2 insulating layer 105-2 may include silicon nitride (SiNx), but the embodiments of the present specification are not limited thereto.

The first source electrode 121 and the first drain electrode 124 may be disposed on the third insulating layers 105-1 and 105-2.

The first source electrode 121 and the first drain electrode 124 may be electrically connected to the first semiconductor layer 123 through contact holes. The first source electrode 121 and the first drain electrode 124 may be formed of a metallic material. For example, the first source electrode 121 and the first drain electrode 124 may be formed of a single layer or multiple layers formed of one of molybdenum (Mo), aluminum (Al), chromium (Cr), gold (Au), titanium (Ti), nickel (Ni), neodymium (Nd), and copper (Cu) or an alloy thereof, but the embodiments of the present specification are not limited thereto.

The first source electrode 121 and the first drain electrode 124 may be disposed along with a data line. For example, the data line may be formed of the same material as the first source electrode 121 and the first drain electrode 124 and formed on the same layer as the first source electrode 121 and the first drain electrode 124, but the embodiments of the present specification are not limited thereto.

A storage electrode 140 may be disposed to be spaced apart from the first thin film transistor 120. The storage electrode 140 may include a first storage electrode 141 and a second storage electrode 142.

The first storage electrode 141 may be formed of the same material as the first gate electrode 122 and disposed on the same layer as the first gate electrode 122, but the embodiments of the present specification are not limited thereto.

The second storage electrode 142 may be disposed on the first storage electrode 141. The second storage electrode 142 may be disposed on the third insulating layers 105-1 and 105-2, and the third insulating layers 105-1 and 105-2 between the first storage electrode 141 and the second storage electrode 142 may be used as a dielectric to generate a capacitance. The second storage electrode 142 may be formed of the same material as the first storage electrode 141, but the embodiments of the present specification are not limited thereto.

The second thin film transistor 130 may be disposed to be spaced apart from the first thin film transistor 120 and the storage electrode 140. The second thin film transistor 130 may include a second source electrode 131, a second gate electrode 132, a second semiconductor layer 133, and a second drain electrode 134.

A second light-blocking layer 136 may be disposed on the same layer as the second storage electrode 142.

The second light-blocking layer 136 can prevent light from traveling to the second semiconductor layer 133 similar to the first light-blocking layer 126, thereby extending the life of the second thin film transistor 130. For example, the second semiconductor layer 133 may be disposed to overlap the second light-blocking layer 136.

A fourth insulating layer 106 may be disposed on the second light-blocking layer 136. The fourth insulating layer 106 may be formed of the same material as the first insulating layer 103, the second insulating layer 104, or the third insulating layers 105-1 and 105-2, but the embodiments of the present specification are not limited thereto.

The second semiconductor layer 133 may be disposed on the fourth insulating layer 106. The second semiconductor layer 133 may include a source area, a drain area, and a channel area between the source area and the drain area.

The second semiconductor layer 133 may include a metal oxide semiconductor, such as indium-gallium-zinc oxide (IGZO), and a silicon-based semiconductor material, such as amorphous silicon, polycrystalline silicon, etc., but the embodiments of the present specification are not limited thereto.

A fifth insulating layer 108 may be disposed on the second semiconductor layer 133. The fifth insulating layer 108 may be formed of the same material as the first insulating layer 103, the second insulating layer 104, the third insulating layers 105-1 and 105-2, or the fourth insulating layer 106, but the embodiments of the present specification are not limited thereto.

The second gate electrode 132 may be disposed on the fifth insulating layer 108.

The second gate electrode 132 may be formed of the same material as the first gate electrode 122. For example, the second gate electrode 132 may be formed of a single layer or multiple layers formed of molybdenum (Mo), copper (Cu), titanium (Ti), aluminum (Al), chromium (Cr), gold (Au), nickel (Ni), neodymium (Nd), or a compound thereof, but the embodiments of the present specification are not limited thereto.

A sixth insulating layer 109 may be disposed on the second gate electrode 132. The sixth insulating layer 109 may be formed of the same material as the first insulating layer 103, the second insulating layer 104, the third insulating layers 105-1 and 105-2, the fourth insulating layer 106, or the fifth insulating layer 108, but the embodiments of the present specification are not limited thereto.

The first source electrode 121, the first drain electrode 124, the second source electrode 131, and the second drain electrode 134 may be disposed on the sixth insulating layer 109.

The second source electrode 131 and the second drain electrode 134 may be formed of the same material as the first source electrode 121 and the first drain electrode 124 and disposed on the same layer as the first source electrode 121 and the first drain electrode 124, but the embodiments of the present specification are not limited thereto. For example, the second source electrode 131 and the second drain electrode 134 may be formed of a single layer or multiple layers formed of any one of molybdenum (Mo), aluminum (Al), chromium (Cr), gold (Au), titanium (Ti), nickel (Ni), neodymium (Nd), and copper (Cu) or an alloy thereof, but the embodiments of the present specification are not limited thereto. For example, the second source electrode 131 may be electrically connected to the second storage electrode 142. The second source electrode 131 may pass through the sixth insulating layer 109, the fifth insulating layer 108, and the fourth insulating layer 106 and may be electrically connected to the second storage electrode 142.

The first thin film transistor 120 may be a driving transistor, and the second thin film transistor 130 may be a switching transistor, but the embodiments of the present specification are not limited thereto.

A first protective layer 111 may be disposed on the first source electrode 121 and the first drain electrode 124.

The first protective layer 111 may planarize upper portions of the first thin film transistor 120 and the second thin film transistor 130 and protect the first thin film transistor 120 and the second thin film transistor 130. The first protective layer 111 may be formed of an organic material. For example, the first protective layer 111 may be formed of an organic material including an acrylic resin, an epoxy resin, a phenolic resin, a polyamide resin, or a polyimide resin, but the embodiments of the present specification are not limited thereto.

The second protective layer 112 may be disposed on the first protective layer 111. The second protective layer 112 may be formed of the same material as the first protective layer 111, but the embodiments of the present specification are not limited thereto.

In some embodiments, a third protective layer may be further disposed on an upper surface of the second protective layer 113, but the embodiments of the present specification are not limited thereto.

A connection electrode 145 may be disposed between the first protective layer 111 and the second protective layer 112.

The connection electrode 145 may electrically connect the thin film transistor 120 and 130 to the light-emitting element ED. FIG. 9 illustrates the connection electrode 145 being in contact with the second source electrode 131 of the second thin film transistor 130 through a contact hole passing through the first protective layer 111, but the embodiments of the present specification are not limited thereto. For example, the connection electrode 145 may be in contact with the first thin film transistor 120 through the contact hole passing through the first protective layer 111.

The connection electrode 145 may be formed of the same material as the first source electrode 121 and the first drain electrode 124, but the embodiments of the present specification are not limited thereto.

The connection electrode 145 may be formed of a single layer or multiple layers formed of one of molybdenum (Mo), aluminum (Al), chromium (Cr), gold (Au), titanium (Ti), nickel (Ni), neodymium (Nd), and copper (Cu) or an alloy thereof, but the embodiments of the present specification are not limited thereto.

The light-emitting element ED may be disposed on the second protective layer 112. The light-emitting element ED is electrically connected to the thin film transistor TFT.

The light-emitting element ED may include a first electrode E1 corresponding to an anode electrode (or a cathode electrode), a light-emitting stack EL formed on the first electrode E1, and a second electrode E2 corresponding to a cathode electrode (or an anode electrode) formed on the light-emitting stack EL.

The first electrode E1 may be in contact with the connection electrode 145 through a contact hole formed in the second protective layer 112 so that the first electrode E1 and the connection electrode 145 may be electrically connected. The first electrode E1 may be electrically connected to the thin film transistor 120 and 130 through the connection electrode 145.

The first electrode E1 may be a reflective electrode that reflects light, but the embodiments of the present specification are not limited thereto. The first electrode E1 may include a metallic material with high reflectance, such as a stacking structure (Ti/Al/Ti) of aluminum (Al) and titanium (Ti), a stacking structure (ITO/Al/ITO) of aluminum (Al) and indium tin oxide (ITO), or an APC alloy and may be formed of a single layer or multiple layers, but the embodiments of the present specification are not limited thereto.

The bank BANK may be disposed on the first electrode E1, may define openings that expose the first electrode E1, and may be disposed to cover an edge portion (a periphery) of the first electrode E1. The openings of the bank BANK may define light-emitting areas of sub-pixels.

The bank BANK may include an organic insulation material. The bank BANK may be formed of an organic material, such as a benzocyclobutene resin, a polyimide resin, an acrylic resin, a photosensitive polymer, etc., but the embodiments of the present specification are not limited thereto.

The embodiments of the present specification are not limited thereto, and the bank BANK may include a black-based material. For example, the bank BANK may be formed of a material containing black pigment, or an organic material, such as a benzocyclobutene resin, a polyimide resin, an acrylic resin, a photosensitive polymer, etc., but the embodiments of the present specification are not limited thereto. When the bank BANK is formed of a material containing black pigment or black dye, the bank 154 may be an opaque bank. When the bank BANK is formed of a material containing black pigment or black dye, it is possible to block external light or light reflected from the outside, thereby further increasing the luminance of the display apparatus.

The light-emitting stack EL is disposed on the first electrode E1 in an light-emitting area defined by the bank BANK. The light-emitting stack EL may have a structure in which a hole-related layer, a light-emitting layer, and an electron-related layer are stacked in that order or in the reverse order on the first electrode E1.

The light-emitting stack EL may be disposed on the first electrode E1. The light-emitting stack EL may include one or more light-emitting structures (or light-emitting elements or elements) stacked in the order or reverse order of a hole transfer layer and an electron transfer layer on the first electrode EL.

For example, the hole transfer layer may include a hole transporting layer, a hole injecting layer, an electron blocking layer, a p-type charge generation layer, etc., but the embodiments of the present specification are not limited thereto. For example, the electron transfer layer may include an electron transporting layer, an electron injecting layer, a hole blocking layer, an n-type charge generation layer, etc., but the embodiments of the present specification are not limited thereto.

The light-emitting stack EL may be an organic light-emitting layer, an inorganic light-emitting layer, a quantum dot light-emitting layer, a micro light-emitting diode, a micro mini light-emitting diode, etc., but the embodiments of the present specification area not limited thereto. For example, the light-emitting stack EL of the display panel DISP according to one embodiment of the present specification may include the organic light-emitting layer. The light-emitting stack EL may include a red light-emitting layer, a green light-emitting layer, and a blue light-emitting layer. The light-emitting stack EL may further include a white light-emitting layer, but the embodiments of the present disclosure are not limited thereto.

The second electrode E2 may be disposed on the light-emitting stack EL. The second electrode E2 is formed opposite to the first electrode E1 with the light-emitting layer EL interposed therebetween. The second electrode E2 may be disposed on the bank BANK as well as the light-emitting stack EL.

The second electrode E2 may be a transparent electrode that transmits light, but the embodiments of the present specification are not limited thereto. For example, the second electrode E2 may include a transparent conductive material, such as indium tin oxide (ITO) or indium zinc oxide (IZO), or a metal that transmits visible light, but the embodiments of the present specification are not limited thereto.

The encapsulation layer ENCAP is disposed on the second electrode E2. The encapsulation layer ENCAP blocks external moisture or oxygen from penetrating the light-emitting element ED that is vulnerable to external moisture or oxygen.

The encapsulation layer ENCAP may be formed of one layer, but may also be formed of multiple layers as illustrated in FIG. 9. For example, when the encapsulation layer ENCAP is formed of multiple layers, the encapsulation layer ENCAP may include one or more inorganic encapsulation layers and one or more organic encapsulation layers. As a specific example, the encapsulation layer ENCAP may have a structure in which a first inorganic encapsulation layer PAS1, an organic encapsulation layer PCL, and a second inorganic encapsulation layer PAS2 are sequentially stacked.

The first inorganic encapsulation layer PAS1 is disposed on the second electrode E2 to be closest to the light-emitting element ED. The first inorganic encapsulation layer PAS1 is, for example, formed of an inorganic insulating material, such as silicon nitride (SiNx), silicon oxide (SiOx), silicon oxynitride (SiON), or aluminum oxide (Al2O3).

The organic encapsulation layer PCL may be formed on the first inorganic encapsulation layer PAS1. The organic encapsulation layer PCL may serve as a buffer to relieve a stress between layers due to bending of the touch display apparatus 100 and serve as a planarization layer. The organic encapsulation layer PCL may be, for example, formed of an organic insulation material, such as an acrylic resin, an epoxy resin, a polyimide, or polyethylene.

The organic encapsulation layer PCL may be dispose between the first inorganic encapsulation layer PAS1 and the second inorganic encapsulation layer PAS2.

The second inorganic encapsulation layer PAS2 may be formed on the organic encapsulation layer PCL. The second inorganic encapsulation layer PAS2 is, for example, formed of an inorganic insulation material, such as silicon nitride (SiNx), silicon oxide (SiOx), silicon oxynitride (SiON), or aluminum oxide (Al2O3).

The touch panel TS may be disposed on the encapsulation layer ENCAP. The touch panel TS may include a touch buffer film T-BUF, the bridge electrode BG, the dummy bridge electrode DB, a touch insulating film T-ILD, the first and second touch electrodes TSE1 and TSE2, the dummy touch electrode DTE, and an overcoat layer OC.

The touch buffer film T-BUF may be disposed on the encapsulation layer ENCAP. The touch buffer film T-BUF may be formed of an inorganic insulation material or an organic insulation material. For example, the touch buffer film T-BUF may be formed of at least one of silicon nitride (SiNx) and silicon oxide (SiOx), but the embodiments of the present specification are not limited thereto.

To reduce parasitic capacitance formed between the first and second touch electrodes TSE1 and TSE2 and the second electrode E2 of the light-emitting element ED, the touch buffer film T-BUF may be disposed between the first and second touch electrodes TSE1 and TSE2 and the second electrode E2. In some cases, the touch buffer film T-BUF may be omitted.

The bridge electrode BG and the dummy bridge electrode DB may be disposed on the touch buffer film T-BUF. The bridge electrode BG and the dummy bridge electrode DB may be disposed to overlap the bank BANK. Accordingly, it is possible to prevent an aperture ratio of the sub-pixel from being reduced by the bridge electrode BG and the dummy bridge electrode DB.

The touch insulating film T-ILD may be disposed to cover the bridge electrode BG and the dummy bridge electrode DB on the touch buffer film T-BUF. The touch insulating film T-ILD may be formed of silicon oxide (SiOx), silicon nitride (SiNx), or multiple layers thereof, but the embodiments of the present specification are not limited thereto.

The first touch electrode TSE1, the dummy touch electrode DTE, and the second touch electrode TSE2 may be disposed on the touch insulating film T-ILD. Specifically, the first and second sensor lines THV and TVL constituting the first touch electrode TSE1, the dummy touch electrode DTE, and the second touch electrode TSE2 may be disposed on the touch insulating film T-ILD.

The plurality of first touch electrodes TSE1 disposed on the touch insulating film T-ILD may be spaced a predetermined distance from each other in the first direction (the X direction). Each of the plurality of first touch electrodes TSE1 may be electrically connected to another adjacent first touch electrode TSE1 through the bridge electrode BG.

Two adjacent first touch electrodes TSE1 may be electrically connected to the bridge electrode BG through a touch contact hole passing through the touch insulating film T-ILD.

The second touch electrodes TSE2 may be spaced a predetermined distance from each other in the first direction (the X direction) on the touch insulating film T-ILD.

The first touch electrode TSE1, the dummy touch electrode DTE, and the second touch electrode TSE2 that have the mesh structure may be disposed to overlap the bank BANK. Accordingly, it is possible to prevent the aperture ratio of the sub-pixel from being reduced by the first touch electrode TSE1, the dummy touch electrode DTE, and the second touch electrode TSE2.

The overcoat layer OC may be disposed on the first touch electrode TSE1, the dummy touch electrode DTE, and the second touch electrode TSE2. The overcoat layer OC may serve to planarize steps formed by the first touch electrode TSE1, the dummy touch electrode DTE, the second touch electrode TSE2, etc. The overcoat layer OC may include an organic insulation material.

A plurality of color filters CF and black matrices BM may be disposed on the overcoat layer OC.

The black matrix BM may be disposed at a location overlapping the bank BANK. The plurality of color filters CF may be disposed at locations overlapping the light-emitting areas defined by the banks BANK.

The black matrix BM may include a black-based material. For example, the black matrix BM may include a light-blocking material or a light-absorbing material. For example, the black matrix BM may be formed of a material including a black pigment, a black dye, etc. The black matrix BM may cover the first touch electrode TSE1, the dummy touch electrode DTE, the second touch electrode TSE2, the bridge electrode BG, and the dummy bridge electrode DB. Accordingly, it is possible to prevent the first touch electrode TSE1, the dummy touch electrode DTE, the second touch electrode TSE2, the bridge electrode BG, and the dummy bridge electrode DB from being visible externally. For example, a width of the black matrix BM may be smaller than a width of the bank BANK.

The plurality of color filters CF may be disposed to overlap the bank BANK. The color filters CF may be disposed in the first to third sub-pixels SPR, SPG, and SPB, respectively, and may block specific colors from light emitted from the light-emitting areas of the sub-pixels SPR, SPG, and SPB, respectively.

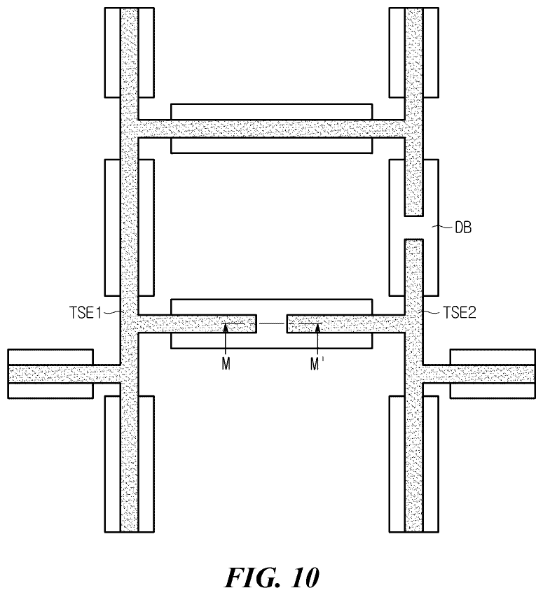

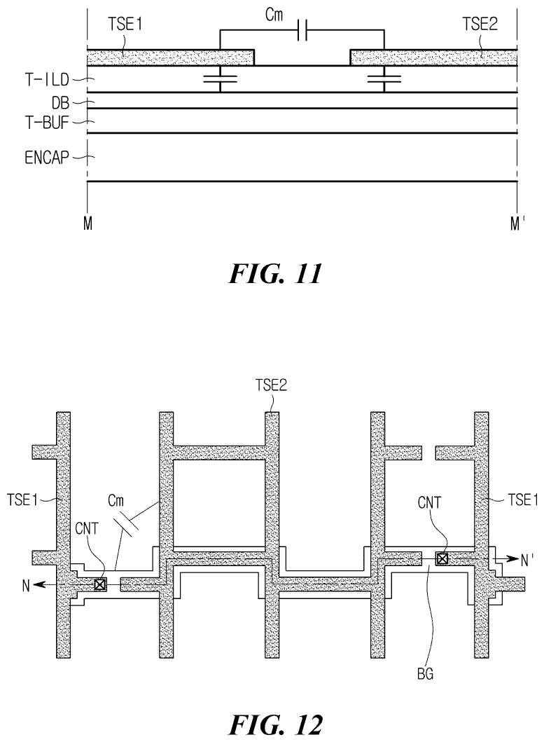

FIG. 10 is a view illustrating the arrangement of the dummy bridge electrode according to one embodiment of the present specification. FIG. 11 is a cross-sectional view along line M-M′ in FIG. 10.

Referring to FIGS. 10 and 11, the dummy bridge electrodes DB may be disposed in a lower layer than the first touch electrodes TSE1 and the second touch electrodes TSE2. The touch buffer layer T-BUF may be disposed on the encapsulation layer ENCAP, and the dummy bridge electrode DB may be disposed on the touch buffer layer T-BUF. The touch insulating film T-ILD may be disposed to cover the dummy bridge electrode DB on the touch buffer layer T-BUF. The first touch electrode TSE1 and the second touch electrode TSE2 may be disposed to be spaced apart from each other on the touch insulating film T-ILD.

The dummy bridge electrode DB may be disposed to overlap the distance between the first touch electrode TSE1 and the second touch electrode TSE2. Accordingly, mutual capacitance Cm between the first touch electrode TSE1 and the second touch electrode TSE2 may be increased. Accordingly, it is possible to improve the touch sensing performance of the touch display apparatus.

FIG. 10 illustrates a line width of the dummy bridge electrode DB being greater than line widths of sensor lines of the first touch electrode TSE1 and line widths of sensor lines of the second touch electrode TSE2, but the embodiments of the present specification are not limited thereto. The line width of the dummy bridge electrode DB may be smaller than or equal to the line widths of the sensor lines of the first touch electrode TSE1 and the line widths of the sensor lines of the second touch electrode TSE2.

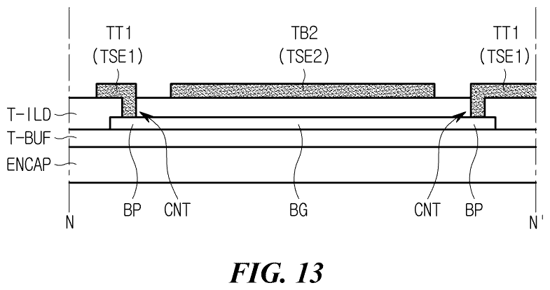

FIG. 12 is a view illustrating the arrangement of the bridge electrode according to one embodiment of the present specification. FIG. 13 is a cross-sectional view along line N-N′ in FIG. 12.

In FIG. 12, dummy bridge electrodes around the bridge electrode are omitted for convenience of description.

Referring to FIGS. 12 and 13, the bridge electrode BG connecting adjacent first touch electrodes TSE1 may be disposed on a lower layer than the first touch electrodes TSE1 and the second touch electrodes TSE2. The touch buffer layer T-BUF may be disposed on the encapsulation layer ENCAP, and the bridge electrode BG may be disposed on the touch buffer layer T-BUF. The touch insulating film T-ILD may be disposed to cover the bridge electrode BG on the touch buffer layer T-BUF.

The first touch electrodes TSE1 disposed on the touch insulating film T-ILD may be in contact with the bridge pads BP at both ends of the bridge electrode BG through contact holes CNT passing through the touch insulating film T-ILD, respectively. Accordingly, the adjacent first touch electrodes TSE1 may be electrically connected through the bridge electrode BG.

The bridge electrode BG connecting the adjacent first touch electrodes TSE1 overlaps a part of the second touch electrode TSE2 disposed on the touch insulating film T-ILD. In this case, by not separating the horizontal sensor lines of the second touch electrode TSE2 overlapping the bridge electrode BG from the vertical sensor lines, the mutual capacitance between the first touch electrode line TSL1 and the second touch electrode line TSL2 may be increased. Accordingly, it is possible to improve the touch sensing performance of the touch display apparatus 100.

A display apparatus according to various embodiments of the present specification may be described as follows.

According to embodiments of the present specification, there is provided a touch display apparatus including a substrate including an active area in which a plurality of sub-pixels are disposed, a plurality of first touch electrode lines disposed on the substrate and extending in a first direction, a plurality of second touch electrode lines disposed on the substrate and extending in a second direction intersecting the first direction, and a plurality of dummy touch electrodes, each of which is disposed between the first touch electrode line and the second touch electrode line, in which the plurality of dummy touch electrodes includes a plurality of patterned dummy touch patterns, respectively.

According to various embodiments of the present specification, the dummy touch electrode may extend in the first direction and have a first length, each of the plurality of dummy touch patterns may extend in the first direction and have a second length, and the second length may range from 15% to 20% of the first length.

According to various embodiments of the present specification, each of the plurality of first touch electrode lines may include a first main electrode extending in the second direction and a first finger electrode protruding from the first main electrode in the first direction, and each of the plurality of second touch electrode lines may include a second main electrode extending in the second direction and a second finger electrode protruding from the second main electrode in the first direction.

According to various embodiments of the present specification, the dummy touch electrode may be surrounded by the first main electrode, the first finger electrode, the second main electrode, and the second finger electrode.

According to various embodiments of the present specification, the dummy touch electrode may be disposed between the first main electrode and the second main electrode in the first direction and between the first finger electrode and the second finger electrode in the second direction.

According to various embodiments of the present specification, the first main electrode, the first finger electrode, the second main electrode, the second finger electrode, and the dummy touch electrode may have a zigzag-shaped exterior.

According to various embodiments of the present specification, the first main electrode and the second main electrode may be alternately disposed repeatedly in the first direction.

According to various embodiments of the present specification, each of the first finger electrode protruding from the first main electrode and the second finger electrode protruding from the second main electrode may be provided as a plurality of finger electrodes.

According to various embodiments of the present specification, lengths of the plurality of dummy touch patterns in the first direction may range from 15% to 20% of a length of at least one of the first finger electrode and the second finger electrode in the first direction.

According to various embodiments of the present specification, each of the plurality of sub-pixels may include a light-emitting area and a non-light-emitting area disposed around the light-emitting area, and each of the first main electrode, the first finger electrode, the second main electrode, and the second finger electrode may be disposed in the non-light-emitting area.

According to various embodiments of the present specification, the plurality of first touch electrode lines may include a first touch electrode including a first main electrode and a first finger electrode and provided as a plurality of first touch electrodes, and a bridge electrode electrically connecting the plurality of adjacent first touch electrodes.

According to various embodiments of the present specification, the first touch electrode, the plurality of second touch electrode lines, and the plurality of dummy touch electrodes may be disposed on the same layer.

According to various embodiments of the present specification, the bridge electrode may be disposed under the first touch electrode.

According to various embodiments of the present specification, the plurality of dummy touch electrodes may be floating.

According to embodiments of the present specification, there is provided a touch display apparatus including a substrate, a first touch electrode disposed on the substrate and including a first main electrode extending in a first direction and a first finger electrode protruding from the first main electrode in a second direction intersecting the first direction, a second touch electrode disposed on the substrate and including a second main electrode extending in the first direction and a second finger electrode protruding from the second main electrode in the second direction, and a dummy touch electrode surrounded by the first touch electrode and the second touch electrode, in which the dummy touch electrode includes a plurality of patterned dummy touch patterns.

According to various embodiments of the present specification, the dummy touch electrode may extend in the first direction and have a first length, each of the plurality of dummy touch patterns may extend in the first direction and have a second length, and the second length may range from 15% to 20% of the first length.

According to various embodiments of the present specification, the dummy touch electrode may be surrounded by the first main electrode, the first finger electrode, the second main electrode, and the second finger electrode.

According to various embodiments of the present specification, the dummy touch electrode may be disposed between the first main electrode and the second main electrode in the first direction and between the first finger electrode and the second finger electrode in the second direction.

According to various embodiments of the present specification, the first main electrode and the second main electrode may be alternately disposed repeatedly in the first direction.

According to various embodiments of the present specification, the plurality of dummy touch electrodes may be floating.

Although the embodiments have been described above with reference to the accompanying drawings, those skilled in the art to which the present specification pertains will be able to understand that the above-described technical configuration can be carried out in other specific forms without changing the technical spirit or essential features thereof. Accordingly, it should be understood that the above-described embodiments are illustrative and not restrictive in all respects. In addition, the scope of the claims is not limited by the disclosure. In addition, the meaning and scope of the claims and all changed or modified forms derived from the equivalent concept thereof should be construed as being included in the scope of the embodiments.

### DESCRIPTION OF REFERENCE NUMERALS

100: display apparatus
SUB: substrate
AA: active area
NA: non-active area
TSL1: first touch electrode line
TSL2: second touch electrode line
TL1: first touch routing line
TL2: second touch routing line
TP1: first touch pad
TP2: second touch pad
TSE1: first touch electrode
TSE2: second touch electrode
TB1: first main electrode
TT1: first finger electrode
TB2: second main electrode
TT2: second finger electrode
DTE: dummy touch electrode
DTP: dummy touch pattern
THL: horizontal sensor line
TVL: vertical sensor line
BG: bridge electrode
BP: bridge pad
DB: dummy bridge electrode
DHL: horizontal dummy line
DVL: vertical dummy line
SPR: first sub-pixel
SPG: second sub-pixel
SPB: third sub-pixel

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A touch display apparatus comprising:
a substrate including an active area;
a plurality of sub-pixels disposed in the active area of the substrate;
a plurality of first touch electrode lines disposed on the substrate and extending in a first direction;
a plurality of second touch electrode lines disposed on the substrate and extending in a second direction intersecting the first direction; and
a plurality of dummy touch electrodes, each of which is disposed between the first touch electrode line and the second touch electrode line,
wherein the plurality of dummy touch electrodes includes a plurality of patterned dummy touch patterns, respectively.

2. The touch display apparatus of claim 1, wherein one of the plurality of dummy touch electrodes extends in the first direction and has a first length,
each of the plurality of dummy touch patterns extends in the first direction and have a second length, and
the second length is 15% to 20% of the first length.

3. The touch display apparatus of claim 1, wherein each of the plurality of first touch electrode lines includes a first main electrode extending in the second direction and a first finger electrode protruding from the first main electrode in the first direction, and
each of the plurality of second touch electrode lines includes a second main electrode extending in the second direction and a second finger electrode protruding from the second main electrode in the first direction.

4. The touch display apparatus of claim 3, wherein the one of the plurality of dummy touch electrodes is surrounded by the first main electrode, the first finger electrode, the second main electrode, and the second finger electrode.

5. The touch display apparatus of claim 4, wherein the one of the plurality of dummy touch electrodes is disposed between the first main electrode and the second main electrode in the first direction and between the first finger electrode and the second finger electrode in the second direction.

6. The touch display apparatus of claim 5, wherein the first main electrode, the first finger electrode, the second main electrode, the second finger electrode, and the one of the plurality of dummy touch electrodes have a zigzag-shaped exterior.

7. The touch display apparatus of claim 4, wherein the first main electrode and the second main electrode are repeatedly and alternately disposed in the first direction.

8. The touch display apparatus of claim 7, wherein the first finger electrode protruding from the first main electrode and the second finger electrode protruding from the second main electrode are provided as a plurality of finger electrodes.

9. The touch display apparatus of claim 3, wherein a length of the plurality of dummy touch patterns in the first direction is 15% to 20% of a length of at least one of the first finger electrode and the second finger electrode in the first direction.

10. The touch display apparatus of claim 3, wherein each of the plurality of sub-pixels includes a light-emitting area and a non-light-emitting area disposed around the light-emitting area, and
each of the first main electrode, the first finger electrode, the second main electrode, and the second finger electrode is disposed in the non-light-emitting area.

11. The touch display apparatus of claim 3, wherein the plurality of first touch electrode lines include a plurality of first touch electrodes, each first touch electrode including a third main electrode and a third finger electrode, the touch display apparatus further comprising:
a bridge electrode electrically connecting adjacent or successive ones of the plurality of first touch electrodes.

12. The touch display apparatus of claim 11, wherein at least one of the plurality of first touch electrodes, the plurality of second touch electrode lines, and the plurality of dummy touch electrodes are disposed on the same layer.

13. The touch display apparatus of claim 12, wherein the bridge electrode is disposed under the at least one of the plurality of first touch electrodes.

14. The touch display apparatus of claim 1, wherein the plurality of dummy touch electrodes are floating.

15. A display apparatus comprising:
a substrate;
a first touch electrode disposed on the substrate and including a first main electrode extending in a first direction and a first finger electrode protruding from the first main electrode in a second direction intersecting the first direction;
a second touch electrode disposed on the substrate and including a second main electrode extending in the first direction and a second finger electrode protruding from the second main electrode in the second direction; and
a dummy touch electrode surrounded by the first touch electrode and the second touch electrode,
wherein the dummy touch electrode includes a plurality of patterned dummy touch patterns.

16. The touch display apparatus of claim 15, wherein the dummy touch electrode extends in the first direction and has a first length,
each of the plurality of dummy touch patterns extends in the first direction and have a second length, and
the second length is 15% to 20% of the first length.

17. The touch display apparatus of claim 15, wherein the dummy touch electrode is surrounded by the first main electrode, the first finger electrode, the second main electrode, and the second finger electrode.

18. The touch display apparatus of claim 17, wherein the dummy touch electrode is disposed between the first main electrode and the second main electrode in the first direction and between the first finger electrode and the second finger electrode in the second direction.

19. The touch display apparatus of claim 17, wherein the first main electrode and the second main electrode are repeatedly and alternately disposed in the first direction.

20. The touch display apparatus of claim 15, wherein the dummy touch electrode is floating.
